(19) United States
(12) Patent Application Publication
(10) Pub. No.: US 2007/0092818 A1
(43) Pub. Date: Apr. 26, 2007

(54) Magnetic single component toner for electrostatic image development and insulation damage suppression method for amorphous silicon photosensitive member

(76) Inventors: Hiroshi Mizuhata, Wakayama-shi (JP); Yukinori Nakayama, Osaka (JP); Kouzou Teramoto, Osaka (JP); Kousuke Satou, Osaka (JP); Akira Tanaka, Osaka (JP)

Correspondence Address: GLOBAL IP COUNSELORS, LLP, 1233 20TH STREET, NW, SUITE 700, WASHINGTON, DC, 20036-2680, US

(21) Appl. No.: 11/258,205

(22) Filed: Oct. 26, 2005

(51) Int. Cl. G03G 9/083

(52) U.S. Cl. 430/108.1; 430/106.1; 430/125

(57) ABSTRACT

A magnetic single component toner for electrostatic latent image development, which is used in a magnetic single component toner projection development method using an a-Si photosensitive member having a film thickness of no more than 30 μm, and a cleaning blade as a cleaning means for removing toner from the surface of this photosensitive member, so as to develop an electrostatic latent image formed on the photosensitive member, with a developing agent bearing member, comprises strontium titanate which has been rendered hydrophobic and has a specific surface area of 8.0 to 30 m²/g, and which is added as an external additive at a ratio of 0.3 to 5.0 parts by mass with respect to 100 parts by mass of the toner particle.

### FIELD OF THE INVENTION

The present invention relates to a dry magnetic single component toner for the development of electrostatic images (electrostatic latent images) formed in electrophotography, electrostatic recording, electrostatic printing and the like, and an insulation damage suppression method for an amorphous silicon photosensitive member.

### BACKGROUND INFORMATION

Generally, in electrophotography, electrostatic recording or the like, a latent image support consisting of a photoconductive photosensitive member, a dielectric or the like is charged by corona charging or the like, and an electrostatic latent image formed by exposure with a laser, an LED or the like is made visible using a developing agent such as toner, or the electrostatic latent image is made visible by reverse development, to obtain a high quality image. In general, as toner applied in these development methods, a dye or a pigment as colorant and charging control agent, wax as a release agent, and a magnetic material or the like are mixed with a thermoplastic resin (binding resin) serving as a binder; kneading, grinding and separating are performed; and the resulting toner particles with a mean particle diameter of 5 to 15 μm are used. Then, with the aim of conferring fluidity with the toner, performing charging control of the toner, or increasing cleanability, inorganic fine powder or inorganic metal fine powder, such as silica, titanium oxide or the like, is added to the toner.

Currently known examples of dry development methods adopted in the various electrostatic copy methods in practical use include the two-component development method, which uses toner and a carrier such as iron powder, and the magnetic single component development method, which uses toner that contains a magnetic body therein, without using a carrier.

In addition, many methods for the development of electrostatic latent images are developed and put into practical use. For instance, several development methods are known, such as the magnetic brush method, the cascade development method and the powder cloud method, as well as the fur brush development method. Among these, in particular, the magnetic brush method, the cascade method and the like, which use a two-component developing agent having a toner and a carrier as the main bodies, are widely used. These methods using a two-component developing agent are relatively stable at the beginning and can provide high quality images; however, when used over a long period, they share common disadvantages of problems, in which, for example, a degradation of the carrier, that is to say, a spent phenomenon, arises, the charging capacity of the carrier drops, and a high quality image cannot be obtained over a long period, and of a poor long-term durability due to difficulty in maintaining the mixing ratio of the toner and the carrier.

In order to avoid such disadvantages, various development methods using a single component developing agent consisting of toner only have been proposed, among which, the magnetic single component development method employing a magnetic toner is generally well known and actively used.

The method of development with an electrically conductive magnetic toner is a well-known development method using a magnetic single component toner. In this method, electrically conductive magnetic toner is borne by an internally magnetized cylindrical electrically conductive developing agent bearing member, and is contacted with an electrostatic latent image for development. In so doing, in the development unit, a conductive path is formed by the toner particles between the latent image support surface and the sleeve surface; an electric charge is guided from the sleeve through this conductive path to the toner particles; and, by the coulomb force to the image portion of the electrostatic latent image, the toner particles are attached to the image portion and developed. With this method, as the toner is electrically conductive, there are problems such as that it is difficult to electrostatically transfer the toner image on the latent image support to a printing medium (for instance ordinary paper) using an electric field, that it is difficult to obtain high image quality over a long term owing to the problematic phenomena originating from the conductive toner at each process, and in addition, a problem of damage to the latent image support due to electrical leakage, and the like.

In addition, a method using insulating toner has been proposed. This method is called magnetic single component projection development method, in which a developing agent bearing member is provided, facing the latent image support, this developing agent bearing member having a development sleeve with a built-in magnet roller; the toner is transported by the rotation of this development sleeve and passed through the gap between the development sleeve and the magnetic blade to form a toner thin layer; and the electrostatic latent image on the latent image support surface is developed by the charged toner. This method has the advantage of preventing background fog and the like, and an excellent image can be obtained.

In this way, the problem of lack of long term durability in the two-component developing agent can be resolved by using the magnetic single component development method. In addition, one of the features of developers used in such a development method is that they may adopt an extremely small and simple constitution.

Current problems have been discussed above centered on the toner; in the following, background art including image forming devices will be described. Currently, although most printers feature an organic photo-conductor (OPC) as a photosensitive member, with increasing high durability of the machines, some that use an amorphous silicon photosensitive member (a-Si photosensitive member) are also in use. In contrast to the life span of OPC, which is on the order of 50,000 copies, the life span of an a-Si photosensitive member is 500,000 copies or more, which makes the machines extremely durable. This is due to the rate of film decay on an a-Si photosensitive member surface being 1/100 the rate of film decay for an OPC or less.

In addition, an image forming method has been proposed, which uses a cleaning blade as a photosensitive member cleaning means, the member thereof being formed from urethane rubber, and uses magnetic toner as a developing agent. This method accomplishes satisfactory cleaning with a simple cleaning mechanism, can form sharp images, does not give rise to image defects such as fog and image unevenness, and does not reduce the image density. However, this method does not provide satisfactory durability. This is because the photosensitive member is an OPC drum, and even if efforts are made in terms of external additives, the soft surface of the OPC drum is prone to damage, and the toner is embedded the damaged photosensitive member surface, which gives rise to filming, or the toner escaping the cleaning blade, which results in flaws that produce critical defects in the image. This is also appreciated from the fact that the durability rating of this image forming device can reach on the order of only 150,000 copies.

On the other hand, a problematic point with using an a-Si photosensitive member resides in long film fabrication time for an a-Si photosensitive member, which reduces productivity and increases cost in comparison with an OPC. Therefore, although the thickness of the film in a conventional a-Si photosensitive member is 30 to 60 μm, photosensitive members using a thin film silicon drum of 30 μm or less have started to be released on the market in recent years, with a view to obtaining high resolution by decreasing the film thickness so as to form a thinner film, as well as in light of the problem of cost.

In addition, the brush type, the blade type and the like exist as cleaning means used in an image forming device using an a-Si photosensitive member; however, many select the blade type, because of reduced product size, and for simplification of the mechanism and the like. Therefore, with a view to aspects such as high durability, high resolution and reduced product size, many systems in use combine a a-Si thin-film photosensitive drum and a cleaning blade.

However, in an image forming device using an a-Si thin-film photosensitive member and also using a blade type cleaning means, insulation damage to the photosensitive member film causes the problem of abnormal images with the conventional magnetic single-component toner. This becomes noticeable because the a-Si photosensitive member is weaker than OPC against insulation damage, furthermore, since the film thickness is that of a thin film. The insulation damage occurs at the blade ridge portion (close to the tip) which cleans the drum, and the toner accumulated there (the same toner and external additive that continue to accumulate) becomes excessively charged (overcharged) by friction with the blade and suddenly discharges when a given upper limit is exceeded. It is believed that, at this moment, the photosensitive member suffers insulation damage because of single-point discharge (discharging to an extremely small region) on the photosensitive member. When this insulation damage occurs, there is a problem that an irreparable flaw occurs, which is damage to the photosensitive layer of the photosensitive member, leaving a noticeable black spot on the image.

Meanwhile, in recent years, the market for copying machines, printers and the like using electrophotography or electrostatic printing, is showing remarkable advances in the acceleration of printing, miniaturization of the machines and extended machine life span. Due to the acceleration of the printing speed, in order to realize image characteristics which suit the printing speed and to improve durability, a toner with stable charging characteristics is indispensable, and a toner that does not influence the course of each process, in particular, with smaller influence on the photosensitive drum that determines the image quality, is desired.

However, a system using a conventional a-Si photosensitive member or OPC, an electrostatic developing agent and a magnetic toner is incapable of fully satisfying high resolution, high image quality, high durability and the like, as mentioned above. In other words, in the current situation, no system has been obtained, which satisfies the combined market demand for a toner with charging characteristics that are stable over a long period of time and little influence on the course of each process, and a photosensitive member that provides long term durability and high resolution.

Furthermore, conventionally, an example using a latent image support consisting of stratified a-Si and a magnetic single-component toner has been presented. According to this method, cleanability can be improved, and satisfactory images can be formed stably over many uses without image defects caused by improper cleaning. However, in this method, organic microparticles are attached (externally added) to a magnetic toner to work as a spacer, but because these organic microparticles have an extremely high charging capacity, they immediately induce a charge build up due to triboelectric charging. This causes the toner to be present in reduced amounts in the appropriate charging regions during the development process, provoking image defects such as a drop in image density, fog and image unevenness, and thus it is not possible to provide stable and clean images over a long period. In addition, in the critical photosensitive member cleaning unit, when an elastic blade with a simple (generic) mechanism is used, although the material of the cleaning blade is not clearly disclosed, as the toner is brought into contact and triboelectrically charged, undue electric charge accumulates in the toner, giving rise, at one point, to an abnormal discharge (single-point discharge, spark discharge) toward the photosensitive member, which damages the photosensitive drum surface (charge generation layer, charge transfer layer), and the probability of generating an irreparable flaw (providing only defective images) becomes extremely high.

In addition, a toner exists in the prior art which has free magnetic powder therein, in order to prevent insulation damage on the photosensitive member. According to this method, leaks can be prevented by the free magnetic powder; however, attachment of the freed magnetic powder onto the development sleeve or the photosensitive member is worrisome. It is well known that if attachment occurs, even in minute quantities, this serves as the nucleus for attachment growth, giving rise to critical image defects.

Furthermore, conventionally, reduction of insulation damage on the photosensitive member by standardizing film thickness in a photosensitive member has been suggested. However, as there is no particular standard for the toner, no measure is taken in regard to toners, which should be the original cause of insulation damages, such that in the future, if a toner with different characteristics is used, insulation damage to the photosensitive member is again worrisome.

Furthermore, conventionally, a toner with strontium titanate microparticles externally added thereto has been proposed, in which case, although stable images can be provided under both low-temperature, low-humidity and high-temperature, high-humidity environments, durability is evaluated to be only 3,000 copies. Therefore, durability may be low. In addition, influence on the photosensitive member is yet unidentified.

In addition, in other prior art, a toner using strontium titanate as polishing agent has been proposed, using this toner on an organic photo-conductor, allows for both attachment to the photo-conductor and prevention of film scraping. However, as the rating is only 20,000 copies, the effectiveness thereof is feared insufficient. In addition, in this prior art, influence on the a-Si photosensitive drum used in recent years with the aim of longer life span is unknown, and there is a risk of insulation damage to the photosensitive member when this toner is used on an a-Si photosensitive drum.

An object of the present invention is to provide, in a magnetic single-component toner projection development method using an amorphous silicon (a-Si) photosensitive member having a film with a thickness of 30 μm or less as a latent image support and a cleaning blade as a cleaning means for removing toner from the surface of this photosensitive member, a magnetic single component toner for electrostatic latent image development capable of preventing insulation damage from occurring on the photosensitive member surface, and an insulation damage suppression method for an a-Si photosensitive member.

### SUMMARY OF THE INVENTION

As a result of earnest studies to solve the above problems, the present inventors made a novel discovery to the effect that, in the development system described above, the occurrence of abnormal images due to insulation damage occurring on the photosensitive member surface could be prevented by using a magnetic single component toner for electrostatic latent image development to which a predetermined quantity of strontium titanate, which has been rendered hydrophobic and has a predetermined range of specific surface area, has been added as an external additive, so that, when toner that accumulates between the a-Si photosensitive member and the cleaning blade becomes charged due to friction with the blade tip, the charge can limited, while at the same time, discharging is enabled before reaching an electric potential that would result in insulation damage to the amorphous photosensitive member, and in this manner the present invention was completed.

That is to say, the magnetic single component toner for electrostatic latent image development of the present invention is a magnetic single component toner for electrostatic latent image development used in a magnetic single component toner projection development method using an amorphous silicon photosensitive member in which the film thickness of a latent image support film is no greater than 30 μm as a latent image support, and a cleaning blade as a cleaning means for removing toner from the surface of this photosensitive member, so as to developed an electrostatic latent image formed on the photosensitive member with a developing agent bearing member, comprising a toner particle comprising at least a binding resin and a magnetic powder, to which is added, as an external additive, at a ratio of 0.3 to 5.0 parts by mass with respect to 100 parts by mass of the toner particle, strontium titanate, which has been rendered hydrophobic and has a specific surface area of 8.0 to 30 m2/g.

A method of the present invention for limiting insulation damage to an amorphous silicon photosensitive member used in a magnetic single component toner projection development method using an amorphous silicon photosensitive member in which the film thickness of a latent image support film is no greater than 30 μm, and a cleaning blade as a cleaning means for removing toner from the surface of this photosensitive member, so as to develop an electrostatic latent image formed on the photosensitive member with a developer holder developing agent bearing member, wherein the method uses the magnetic single component toner for electrostatic latent image development as recited above as toner.

As a predetermined quantity of strontium titanate, which has been rendered hydrophobic and has specific surface area in a predetermined range, is added to the toner, triboelectric charging between the toner and the cleaning blade can be limited, while allowing discharge reaching an electric potential that would give rise to insulation damage on the amorphous photosensitive member, so that sharp images with no abnormal image due to insulation damage on the photosensitive member can be obtained, and consequently, the magnetic single component toner for electrostatic latent image development and insulation damage suppression method for an a-Si photosensitive member of the present invention have the effect of producing stable image quality, not only initially, but also in the long term.

### BRIEF DESCRIPTION OF THE DRAWINGS

FIG. 1 is a schematic drawing showing one example of an image forming device.

FIG. 2 is a cross sectional enlarged view showing a portion of a layered structure of an amorphous silicon photosensitive drum.

FIG. 3 is a graph showing the relationship between photosensitive member film thickness and needle withstand voltage.

### DETAILED DESCRIPTION OF THE PREFERRED EMBODIMENTS

(Image Forming Device)

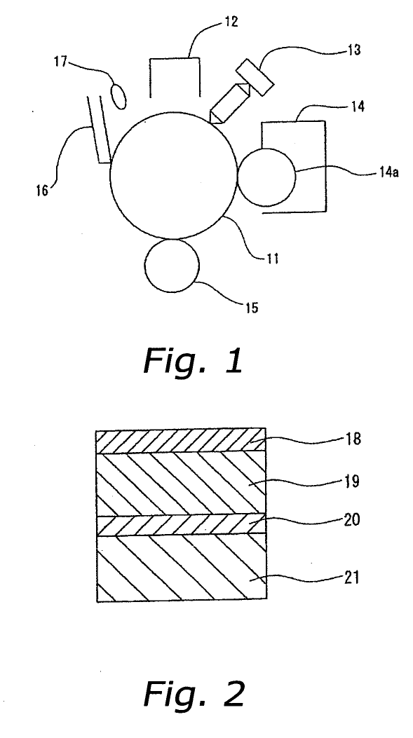

Hereinafter, the present invention will be described in detail with reference to the drawings. FIG. 1 is a schematic view showing the periphery of the photosensitive member of the image forming device using the magnetic single component toner for electrostatic latent image development of the present invention. As shown in FIG. 1, this image forming device comprises a development system employing a magnetic single-component toner projection development method, and uses a positively charging amorphous silicon (a-Si) photosensitive drum 11 as a latent image support. A scorotron charger 12, an exposer 13, a developer 14, a transfer roller 15, a cleaning blade (cleaning means) 16 and an eraser lamp (erasing means) 17 are located in the periphery of the a-Si photosensitive drum 11.

In this image forming device, the a-Si photosensitive drum 11 is charged by the scorotron charger 12 and exposed with an optical signal produced by converting printing data to form an electrostatic latent image on the photosensitive drum 11. Meanwhile, in the developer 14, toner is transported by the rotation of a development sleeve 14a (developing agent bearing member) located opposite to the photosensitive drum 11 and having a built-in magnet roller (not shown) fixed inside, and this toner passes between the magnetic blade (not shown) and the development sleeve 14a to form a toner thin layer on the surface of the development sleeve 14a. Then, toner is supplied from this toner thin layer onto the photosensitive drum 11, to develop the electrostatic latent image formed on the photosensitive drum 11.

The developed toner image is transferred onto a transfer medium (such as printing paper) by a transfer roller 15. Meanwhile, the toner accumulated without being transferred to the transfer medium and remaining on the surface of the photosensitive drum 11 (waste toner) is removed by the cleaning blade 16. This waste toner is temporarily retained near the tip of the cleaning blade 16, and, by gradually being pushed out by the subsequent waste toner towards a transport member such as a screw roller, which is not shown, is transported into a waste toner container (not shown). From the surface of the photosensitive drum 11 from which the waste toner has been removed, residual image charge is removed by the eraser lamp 17.

(Photosensitive Drum)

FIG. 2 is an enlarged cross sectional view of a portion of the a-Si photosensitive drum 11. As shown in FIG. 2, a drum with a plurality of layers constituted by stratifying a carrier stop layer 20, a photosensitive layer 19 and a surface protective layer 18 over an electrically conductive substrate 21 is preferably used as the photosensitive drum 11.

In addition, the present invention uses an a-Si thin film photosensitive drum 11, and not a conventional a-Si photosensitive drum. The thickness of the film in the photosensitive member 11 is 30 μm or less, preferably 10 to 30 μm. Here, in the present mode of embodiment, the thickness of the film in the a-Si photosensitive drum 11 refers to the thickness from the surface of the electrically conductive substrate 21, which is the substrate, to the surface of the photosensitive drum 11, that is to say, the sum of the thickness of the carrier stop layer 20, photosensitive layer 19 and the surface protective layer 18.

If the thickness of the film in the photosensitive drum 11 exceeds 30 μm, the dark decay characteristics (the ability of the photosensitive layer to maintain electric charge in the dark as a function of time) drop due to the acceleration of the heat carrier's displacement speed, and consequently, the latent image tends to flow on the photosensitive member surface in the direction of the rotation of the photosensitive member, causing a drop in the resolution. It is well known that the resolution becomes better as the thickness of the film in the photosensitive member decreases, and that this is not limited to —Si photosensitive members, but also holds true for organic photo-conductors (OPC). In regard to costs, with a greater thickness of the film for the photosensitive member, the film forming time becomes longer, which increases the probability of attachment of foreign substances or the like and reduces the manufacturing efficiency; thus, with a smaller total thickness for the film in the photosensitive member, the cost is lowered and the quality becomes more stable. On the other hand, if the thickness of the film in the photosensitive drum 11 is 10 μm or less, the charging capacity of the photosensitive member may drop, which may make it difficult to obtain the predetermined surface potential. In addition, there is also a risk that a diffuse reflection of the laser beam on the surface of the electrically conductive substrate 21 generates interference fringes in half patterns. Therefore, from the point of view of charging capacity, withstand voltage, dark decay characteristics, manufacturing costs and quality, a range of 10 to 30 μm is preferred for the thickness of the film in the photosensitive drum 11.

In a more preferred mode for the photosensitive drum 11, the thickness of the surface protective layer 18 is 20,000 Å or less, and preferably from 5,000 to 15,000 Å. If the thickness of the surface protective layer 18 is less than 5,000 Å, the withstand voltage characteristics against an influx of negative electric current having an opposite polarity to the charging polarity from the transfer roller 15 drops, and as a result, there is a risk that the surface protective layer 18 will degrade as early as at 15,000 copies or less. On the other hand, if the thickness of the surface protective layer 18 exceeds 20,000 Å, the film forming time becomes long, which is disadvantageous in terms of costs. Consequently, a range of 5,000 to 15,000 Åis adequate for the thickness of the surface protective layer 18, from the viewpoint of balancing among charging capacity, wear resistance, environment resistance and film forming time.

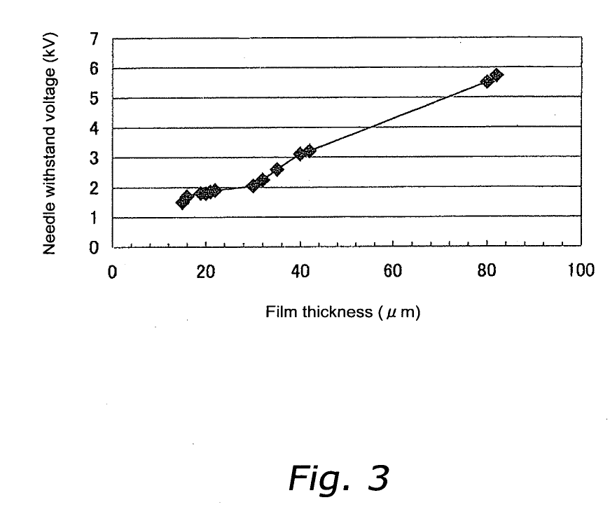

FIG. 3 is a graph showing the relationship between the thickness of the film in a photosensitive drum and needle withstand voltage. As shown in FIG. 3, the voltage at which insulation damage to the photosensitive layer starts to occur increases along with increasing film thickness, and with the film becoming thinner, the voltage at which the insulation damage starts to occur is lowered. As mentioned in the foregoing, the occurrence of black spots on the image due to insulation damage on the photosensitive layer largely depends on the thickness of the film in the photosensitive member. Therefore, in a development system using a photosensitive drum 11 with a film as thin as 30 μm or less, as there is a high probability that insulation damage may occur even at a low voltage, the toner of the present invention, which is capable of preventing over-charging, is particularly effective.

There are no particular limits on the material that constitutes the photosensitive layer 19 (photosensitive layer material) as long as it is amorphous silicon (a-Si). Examples of preferred materials include inorganic materials such as a-Si, a-SiC, a-SiO, a-SiON and the like. Among these materials, in particular a-SiC is highly resistant; furthermore, from the viewpoint of obtaining high charging capacity, wear resistance and environmental resistance, it is an excellent photosensitive layer material for the present mode of embodiment.

In addition, when using a-SiC, it is preferable to use those with the ratio between Si and C (carbon) in a predetermined range. It is preferred that such a-SiC includes a-Si_{1-X}C_{X} (where the value of X is 0.3 or greater and less than 1) and preferably a-Si_{1-X}C_{X} (where the value of X is 0.5 or greater and 0.95 or less). The a-SiC having a ratio between Si and C in the above-mentioned range has a particularly high resistance, from 10¹² to 10¹³Ω cm, and the flow of latent image charges in the photosensitive member direction on the photosensitive member surface is small, which results in an excellent capacity to maintain the electrostatic latent image and resistance to humidity.

In addition, an OPC generally having a surface resistance on the order of 10¹³Ω/square, which is higher than the surface resistance of an a-Si photosensitive member (on the order of 10⁸Ω/square), is less prone to insulation damage, so black spots due to leakage does not readily occur; however, an a-Si photosensitive member has better abrasion resistance than OPC. Therefore, in a development system using an a-Si photosensitive member, the magnetic single component toner for electrostatic latent image development of the present invention capable of preventing over-charging allows for both prevention of insulation damage and improved abrasion resistance.

The surface potential (charging potential) of the a-Si photosensitive drum 11 may be in the range of +200 to +500V, and preferably in the range of +200 to +300V. If the surface potential is less than +200, the development field becomes insufficient, which makes it difficult to maintain the image density. On the other hand, if the surface potential exceeds +500, depending on the thickness of the film in the photosensitive drum 11, there are problems such as that the charging capacity becomes insufficient, that black spots occur more easily on the image resulting from insulation damage on the photosensitive layer, or that the amount of ozone generated increases. In particular, when the thickness of the film in the photosensitive member 11 is thin, correspondingly, the charging capacity of the photosensitive drum 11 tends to drop. Consequently, from the viewpoint of balancing the development ability and charging capacity of the photosensitive member, the surface potential on the surface of the a-Si photosensitive drum 11 is preferably in the above-mentioned range.

With a conventional toner, when the linear speed of the photosensitive drum increases, the toner becomes more prone to triboelectric charging, and therefore insulation damage occurs more easily; however, according to the toner of the present invention, even when the linear speed is high, for instance as high as from 400 to 500 mm/second, insulation damage can be reduced.

(Developer)

It is preferred that the development sleeve 14a has a ten point mean roughness Rz on the front side thereof of no less than 2.0 μm and no more than 6.0 μm. If the ten point mean roughness Rz is 2.0 μm or less, there is a risk that the image density will decease due to a drop in the toner transport capacity. If the Rz exceeds 6.0 μm, the image quality degrades, and leakage occurs from the protuberance on the surface of sleeve 14a to the photosensitive drum 11, compromising image quality by leaving black spots on the image. The ten point mean roughness Rz can be measured using a surface roughness meter, for instance, the “Surfcorder SE-30D” manufactured by Kosaka Laboratory Ltd.

As for materials used for the development sleeve 14a, for instance, aluminum, stainless steel (SUS) or the like may be used. When considering high durability, the use of SUS steel as sleeve material is preferred, and, for instance, SUS303, SUS304, SUS305, SUS316 or the like can be used. In particular, it is most preferable to use SUS305, which has weak magnetism and is easier to machine.

(Charger)

A scorotron charger 12 comprises a shielding case, a corona wire, a grid and the like, the distance between the corona wire and the grid being preferably set to 5.3 to 6.3 mm. In addition, it is preferred that the distance between the grid and the photosensitive drum 11 be 0.4 to 0.8 mm. If this distance is 0.4 mm or less, there is a possibility that a spark discharge occurs, and if it exceeds 0.8 mm, there is a problem in that the charging capacity drops.

(Transfer Roller)

Preferably, the transfer roller 15 is in contact with the photosensitive drum 11 and driven so as to rotate with a linear speed difference of 3 to 5% with respect to the photosensitive drum 11. If this linear speed difference is less than 3%, transferability drops, and there is a risk of blank portions being formed; on the other hand, if the linear speed difference exceeds 5%, there is the risk of slippage between the transfer roller 15 and the photosensitive drum 11 becoming great and increasing jitter.

Preferably, the material used for the transfer roller 15 is expanded EPDM (foam member made of ethylene-propylene-diene three-way copolymer). By using such a foam member, when paper jams or the like occur, contaminating toner enters the air spaces in the foam, so that the back of the first paper to pass though after resuming the run is not soiled. In addition, by using expanded-type materials, there is no need to clean the transfer roller 15, which reduces costs. The hardness of the rubber of the transfer roller 15 is preferably 35°±5° (Asker C: “SRIS-0101 C Type”, Standard of the Rubber Industry Society of Japan). If this rubber hardness is less than 30°, a transfer defect occurs, and if greater than 40°, nipping with the photosensitive drum 11 is reduced so that the transport force drops.

(Cleaning Blade)

In the present mode of embodiment, a cleaning blade 16 is used as a cleaning means for the surface of the photosensitive drum 11. This cleaning blade 16 is located downstream from the transfer roller 15 in the direction of rotation of the photosensitive drum 11, and the tip thereof is in contact with the photosensitive drum 11. In this way, remaining waste toner that has accumulated on the surface of the photosensitive drum 11 without being transferred onto the transfer medium can be removed.

Preferably, the cleaning blade 16 is a resilient blade having elasticity. This prevents the surface of the photosensitive drum 11 from being damaged. Examples of resilient materials include, for instance, urethane rubber, silicone rubber, elastic resin and the like. The cleaning blade 16 is obtained by forming a resilient material into a blade shape, or by mounting a resilient material at the tip of a blade made of metal or the like.

<Magnetic Single Component Toner>

The magnetic single component toner for electrostatic latent image development of the present invention is obtained by adding a predetermined external additive to toner particles containing at least a binding resin and a magnetic powder.

(Binding Resin)

Although there are no particular restrictions on the type of binding resin used in the toner of the present invention, thermoplastic resins are preferably used, such as, for instance, styrene resins, acrylic resins, styrene-acrylic copolymers, polyethylene resins, polypropylene resins, polyvinyl chloride resins, polyester resins, polyamide resins, polyurethane resins, polyvinyl alcohol resins, vinyl ether resins, N-vinyl resins, and styrene-butadiene resins.

More specifically, a polystyrene resin can be a styrene homopolymer, or a copolymer with another copolymerization monomer that is copolymerizable with styrene. Examples of copolymerization monomers include, p-chlor-styrene; vinyl naphthalene; ethylene unsaturated monoolefins such as ethylene, propylene, butylene and isobutylene; halogenated vinyls such as polyvinyl chloride, vinyl bromide and vinyl fluoride; vinyl esters such as vinyl acetate, vinyl propionate, vinyl benzoate and vinyl butyrate; (meta) acrylic acid esters such as methyl acrylate, ethyl acrylate, n-butyl acrylate, isobutyl acrylate, dodecyl acrylate, n-octyl acrylate, 2-chlor-ethyl acrylate, phenyl acrylate, methyl-α-chlor-acrylate, methyl meta-acrylate, ethyl meta-acrylate and butyl meta-acrylate; other acrylic acid derivatives such as acrylonitrile, meta-acrylonitrile and acrylamide; vinyl ethers such as vinyl methyl ether and vinyl isobutyl ether; vinyl ketones such as vinyl methyl ketone, vinyl ethyl ketone and methyl isopropenyl ketone; N-vinylated compounds such as N-vinyl pyrrole, N-vinyl carbazole, N-vinyl indole, N-vinyl pyrrolidene, and the like. These can be used alone or two or more species can be combined, and copolymerized with a styrene homopolymer.

In addition, a polyester resin can be used as long as it is obtained by condensation polymerization or condensation copolymerization of an alcohol component and a carboxylic acid component. Examples of components used when synthesizing a polyester resin include the following. First, examples of secondary and tertiary and higher alcohols include diols such as ethylene glycol, diethylene glycol, triethylene glycol, 1,2-propylene glycol, 1,3-propylene glycol, 1,4-butanediol, neopentyl glycol, 1,4-butene diol, 1,5-pentane diol, 1,6-hexane diol, 1,4-cyclohexane dimethanol, dipropylene glycol, polyethylene glycol, polypropylene glycol and polytetramethylene glycol; bisphenols such as bisphenol A, bisphenol A hydrogenate, bisphenol A polyoxyethylene and bisphenol A polyoxypropylene; and tertiary and higher alcohols, such as sorbitol, 1,2,3,6-hexane tetrol, 1,4-sorbitane, pentaerythritol, dipentaerythritol, tripentaerythritol, 1,2,4-butane triol, 1,2,5-pentanetriol, glycerol, diglycerol, 2-methylpropane triol, 2-methyl-1,2,4-butane triol, trimethylol ethane, trimethylol propane and 1,3,5-trihydroxymethyl benzene.

In addition, a divalent or a trivalent carboxylic acid, an acid anhydride thereof or a lower alkyl ester is used as a divalent, trivalent or higher carboxylic acid component, examples of which include divalent carboxylic acids such as maleic acid, fumaric acid, citraconic acid, itaconic acid, gluconic acid, phthalic acid, isophthalic acid, terephthalic acid, cyclohexane dicarboxylic acid, succinic acid, adipic acid, sebacic acid, azelaic acid, malonic acid, or alkyl or alkenyl succinic acids, such as n-butyl succinic acid, n-butenyl succinic acid, isobutyl succinic acid, isobutenyl succinic acid, n-octyl succinic acid, n-octenyl succinic acid, n-dodecyl succinic acid, n-dodecenyl succinic acid, isododecyl succinic acid and isododecenyl succinic acid; and divalent, trivalent or higher carboxylic acids, such as 1,2,4-benzene tricarboxylic acid (trimellitic acid), 1,2,5-benzene tricarboxylic acid, 2,5,7-naphthalene tricarboxylic acid, 1,2,4-naphthalene tricarboxylic acid, 1,2,4-butane tricarboxylic acid, 1,2,5-hexane tricarboxylic acid, 1,3-dicarboxylic-2-methyl-2-methylene carboxypropane, 1,2,4-cyclohexane tricarboxylic acid, tetra(methylene-carboxyl)methane, 1,2,7,8-octane tetra carboxylic acid, pyromellitic acid, and EMPOL trimeric acid. In addition, the softening point of the polyester resin is 110 to 150° C., more preferably 120 to 140° C.

In addition, the binding resin may be a thermosetting resin. In this way, by partially introducing a cross-linking structure, storage stability and morphological stability, or durability of the toner can be increased without reducing fixing characteristics. Thus, there is no need to use 100 parts by mass of thermoplastic resin as the toner binding resin, and addition of a cross-linking agent, or partial use of thermosetting resin, is also preferred.

Therefore, epoxy resins and cyanate resins, or the like, can be used as thermosetting resins. More specifically, examples include bisphenol A-type epoxy resins, bisphenol A hydrogenate-type epoxy resins, novolack-type epoxy resins, polyalkylene ether-type epoxy resins, cyclic aliphatic-type epoxy resins, cyanate resin or the like, alone or in combinations of two or more.

In addition, in the present invention, the glass transition point (Tg) of the binding resin is preferably 50 to 65° C., and more preferably 50 to 60° C. If this glass transition point is lower than the above-mentioned range, the obtained toner particles are fused to each other in the developer, and the storage stability drops. In addition, as the resin strength is low, the toner tends to adhere to the photosensitive member. Furthermore, if the glass transition point is higher than the above-mentioned range, the low-temperature fixing characteristics of the toner are reduced. It should be noted that the glass transition point of the binding resin can be obtained from the specific heat change point using a differential scanning calorimeter (DSC). More specifically, it was obtained by measuring the heat absorption curve using a differential scanning calorimeter DSC-6200 manufactured by Seiko Instruments as the measurement device. Placing 10 mg of measurement sample in an aluminum pan and using an empty aluminum pan as a reference, measurement was performed at room temperature and ambient humidity, with a measurement temperature range of 25 to 200° C., at a temperature elevation speed of 10° C./minute, to determine the glass transition point from the obtained heat absorption curve.

(Magnetic Powder)

In the magnetic single component toner for electrostatic latent image development of the present invention, the binding resin contains a magnetic powder. Examples of such magnetic powders include those that are well known per se, for instance, metals demonstrating ferromagnetism such as iron, cobalt and nickel including ferrites and magnetites thereof, or alloys or compounds containing these elements, or alloys that do not contain ferromagnetic elements but demonstrate ferromagnetism as the result of suitable heat treatment, or chromium dioxide and the like.

These magnetic powders are homogeneously dispersed in the above-mentioned binding resin, in the form of fine powder with a mean particle diameter in the range of 0.1 to 1.0 μm, and in particular 0.1 to 0.5 μm. In addition, the magnetic powder can be used after performing a surface treatment with a surface treatment agent such as titanium coupling agent and silane coupling agent.

In addition, it is preferred that the magnetic powder be contained in the toner (with the total amount of toner being 100 parts by mass) at a proportion of 35 to 60 parts by mass, and preferably 40 to 60 parts by mass. If a larger quantity than the above range of magnetic powder is used, durability of image density degrades, and in addition, fixing characteristics tend to be greatly reduced; if the quantity is less than the above range, fogging becomes worse in terms of the image density permanence.

In the magnetic single component toner for electrostatic latent image development of the present invention, various toner compounding agents, such as a colorant, a charge control agent and wax, are dispersed in the binding resin, in addition to the above magnetic powder.

(Colorant)

In the toner of the present invention, a pigment such as carbon black or a dye such as acid violet can be dispersed in the binding resin, as a colorant for modifying the color tone, in the same way as those that are well known. Such colorants are mixed in general with a proportion of 1 to 10 parts by mass to 100 parts by mass of the above binding resin.

(Charge Control Agent)

A charge control agent is mixed because this greatly improves charge levels and charge-up characteristics (indicator of how quickly it can be charged to a given charge level) and to obtain excellent durability and stability. That is to say, when the toner is to be charged positively and supplied to the development process, a positively chargeable charge control agent can be added, and when the toner is to be negatively charged and supplied to the development process, a negatively chargeable charge control agent can be added.

There are no particular restrictions on such charge control agents, and specific examples of positively chargeable charge control agents can include, for instance, azine compounds such as pyridazine, pyrimidine, pyrazine, orthooxazine, metaoxazine, paraoxazine, orthothiazine, metathiazine, parathiazine, 1,2,3-triazine, 1,2,4-triazine, 1,3,5-triazine, 1,2,4-oxadiazine, 1,3,4-oxadiazine, 1,2,6-oxadiazine, 1,3,4-thiazidine, 1,3,5-thiazidine, 1,2,3,4-tetrazine, 1,2,4,5-tetrazine, 1,2,3,5-tetrazine, 1,2,4,6-oxatriazine, 1,3,4,5-oxatriazine, phthalazine, quinazoline and quinoxaline; direct dyes consisting of azine compounds, such as azine fast red FC, azine fast red 12BK, azine violet BO, azine brown 3G, azine light brown GR, azine dark green BH/C, azine deep black EW and azine deep black 3RL; nigrosine compounds, such as nigrosine, nigrosine salts and nigrosine derivatives; acid dyes consisting of nigrosine compounds, such as nigrosine BK, nigrosine NB and nigrosine Z; metal salts of naphthenic acid or higher fatty acids; alkoxyl amine; alkyl amide; and quaternary ammonium salts, such as benzylmethylhexyldecyl ammonium and decyltrimethyl ammonium chloride, and these may be used alone or in combinations of two or more. In particular, with a view to achieving rapid charge-up, the use of nigrosine compounds is optimal for a positively chargeable toner.

In addition, resins, oligomers and the like, having a quaternary ammonium salt, a carboxylate or a carboxyl group as a functional group, can also be used as a positively chargeable charge control agent. More specifically, examples include styrene resins having a quaternary ammonium salt, acrylic resins having a quaternary ammonium salt, styrene-acrylic resins having a quaternary ammonium salt, polyester resins having a quaternary ammonium salt, styrene resins having a carboxylate, acrylic resins having a carboxylate, styrene-acrylic resins having a carboxylate, polyester resins having a carboxylate, polystyrene resins having a carboxyl group, acrylic resins having a carboxyl group, styrene-acrylic resins having a carboxyl group, polyester resins having a carboxyl group, and the like, and these may be used alone or in combinations of two or more.

In particular, a styrene-acrylic copolymer resin having a quaternary ammonium salt as a functional group is optimal from the viewpoint of the ability to readily adjust the charge to a value in a desired range. In this case, examples of preferred acrylic co-monomers to be copolymerized with the above styrene unit include alkyl ester (meta) acrylates, such as methyl acrylate, ethyl acrylate, n-propyl acrylate, iso-propyl acrylate, n-butyl acrylate, iso-butyl acrylate, 2-ethylhexyl acrylate, methyl meta-acrylate, ethyl meta-acrylate, n-butyl meta-acrylate and iso-butyl meta-acrylate. In addition, a unit derived from dialkyl aminoalkyl(meta)acrylate through a quaternization process is used as a quaternary ammonium salt. Excellent examples of derived dialkyl aminoalkyl(meta)acrylates include, for instance, di(lower alkyl)aminoethyl(meta)acrylates, such as dimethyl aminoethyl(meta)acrylate, diethyl aminoethyl(meta)acrylate, dipropyl aminoethyl(meta)acrylate and dibutyl aminoethyl(meta)acrylate; dimethyl methacrylamide and dimethyl aminopropyl methacrylamide. In addition, at polymerization time, it is also possible to use in combination a hydroxy group-containing polymerizable monomer, such as hydroxy ethyl(meta)acrylate, hydroxy propyl(meta)acrylate, 2-hydroxy butyl(meta)acrylate or N-methylol(meta)acrylamide.

Organic metal complexes and chelating compounds, for instance, are effective as charge control agents demonstrating negative chargeability, examples thereof including aluminum acetylacetonate, iron (II) acetylacetonate, chromium 3,5-di-tert-butyl salicylate and the like; in particular, acetyl acetone metal complexes, salicylic acid metal complexes or salt are preferred; and in particular, salicylic acid metal complexes or salicylic acid metal salts are preferred.

It is preferred that the above positively chargeable or negatively chargeable charge control agents be contained in the toner in proportions of, in general, 1.5 to 15 parts by mass, preferably 2.0 to 8.0 parts by mass, more preferably 3.0 to 7.0 parts by mass (the total amount of toner being 100 parts by mass). If the amount of charge control agent added is less than the above-mentioned range, stably charging the toner with a predetermined polarity tends to be difficult, and if this toner is used to perform development of an electrostatic latent image and perform image forming, the image density tends to drop, and durability of the image density tends to drop. In addition, dispersion of the charge control agent tends to be poor, causing a so-called fog, and contamination of the photosensitive member tends to be severe. On the other hand, if a greater amount than the above-mentioned range of charge control agent is used, problems occur more readily, including in terms of environmental resistance, and in particular charging defects and image defect under high temperature and high humidity, as well of in terms of contamination of the photosensitive member contamination.

(Wax)

There is no particular limitation on the waxes used to improve fixing and offset, and, for instance, polyethylene wax, polypropylene wax, Teflon™ wax, Fischer-Tropsch wax, paraffin wax, ester wax, Montan wax, rice wax or the like can be used. These waxes may be used in combinations of two or more. By adding such waxes, offset and image smearing can be prevented more effectively.

Although there is no limitation on the above-mentioned waxes, they are preferably admixed to the toner at quantities of 1 to 5 parts by mass, in general (the total amount of toner being 100 parts by mass). If the amount of waxes added is less than one part by mass, offset and image smearing or the like may not be effectively prevented; on the other hand, if exceeding 5 parts by mass, the toner fuses to itself, and the storage stability tends to be reduced.

(Strontium Titanate)

In the magnetic single component toner for electrostatic latent image development of the present invention, strontium titanate, which has been rendered hydrophobic, is an external additive added as a polishing agent microparticle. Although conventionally, titanium oxide has been generally used as polishing agent microparticle, titanium oxide has the property of aggregating easily, causing image problems such as fog, and in addition, it impedes fluidity; thus, the problems that are likely to arise must be considered when this is used as a polishing agent. Furthermore, it has not been seen to be particularly effective in preventing worrisome insulation damage on photosensitive members in long duration systems. However, the present inventors found that, in terms of materials, strontium titanate did not aggregate in the manner of titanium oxide, and fluidity was not degraded, but rather this could be used as a fluidization agent. Furthermore, among the factors causing insulation damage on the photosensitive member, there is the discharge that occurs from the toner to the photosensitive member surface due to an abnormal increase in the charge that the toner has accumulated in the contact portion between the cleaning blade and the photosensitive member; however, the present inventors also found that compared to titanium oxide, strontium titanate is also effective in preventing an undesirable rise in charge, and thus can effectively prevent insulation damage to the photosensitive member, by limiting the rise in charge.

The specific surface area of this strontium titanate, which has been rendered hydrophobic, as used in the present invention is 8.0 m²/g to 30 m²/g, and preferably 11.0 m²/g to 27.0 m²/g. If the specific surface area is greater than the above-mentioned range, the polishing effect becomes too weak to function as a polishing agent, and there is the risk of contaminating the photosensitive member. Conversely, if it is less than the above-mentioned range, the photosensitive member is not polished but damaged; moreover, there is no effective prevention of insulation damage to the photosensitive member. In addition, separation from the toner occurs more easily, which has a negative effect on image characteristics, such as fog and reduced density.

The specific surface area in the present invention generally refers to BET specific surface area by nitrogen adsorption, and can be measured by using a model 2200 BET specific surface area analyzer manufactured by Micromeritic.

The amount of strontium titanate added to toner particle is 0.3 to 5.0 parts by mass, preferably 0.5 to 4.0 parts by mass, for 100 parts by mass of toner particle. If the amount is less than the above-mentioned range, the polishing effect decreases, giving rise to photosensitive member contamination, and the effects of the present invention become difficult to obtain. If it is more than the above-mentioned range, it may not adhere to the toner surface strongly and may come free, which may have a negative effect on image characteristics such as fog, which is an excessive influence on the toner.

It is preferred that strontium titanate be subjected to surface treatment by a hydrophobizing agent to confer hydrophobicity, preferably to a degree of hydrophobization of 35% or more, and in particular, more preferably to 40% to 75%. A toner with high environmental stability can be achieved by adding strontium titanate as an external additive having a degree of hydrophobization such as mentioned above. As a hydrophobizing agent for such surface treatment, various well known agents can be used, and, for instance, silane coupling agent, titanate coupling agent, silicone oil, silicone varnish or the like may be cited. For instance, hexamethyl disilazane, trimethyl silane, trimethyl chlor-silane, dimethyl dichlor-silane, methyl trichlo-silane, allyldimethyl chlor-silane, benzyldimethyl chlor-silane, methyltrimethoxy silane, methyltriethoxy silane, isobutyltrimethoxy silane, dimethyldimethoxy silane, dimethyldiethoxy silane, trimethylmethoxy silane, hydroxypropyltrimethoxy silane, phenyltrimethoxy silane, n-butyltrimethoxy silane, n-hexadecyltrimethoxy silane, n-octadecyltrimethoxy silane, vinyltriethoxy silane, γ-methacryloxypropyltrimethoxy silane, vinyltriacetoxy silane or the like can be used as the silane coupling agent; and, for instance, dimethylpolysiloxane, methylhydrodiene polysiloxane, methylphenyl polysiloxane, or the like can be used as the silicone oil. Strontium titanate itself is not water soluble; however, by performing a hydrophobizing process such as described above, various toner characteristics can be stably achieved with respect to environmental variations, and in particular humidity change. If strontium titanate is used as an external additive without performing hydrophobizing treatment, problems such as large decreases in image density can for example occur in a highly humid environment.

The degree of hydrophobization in the present invention represents the degree of hydrophobization by the methanol method, and can be determined according to the measurement method described in the following. That is to say, 0.1 g of strontium titanate is weighed in a 200 ml beaker, to which 50 ml of pure water is added, and methanol is added under the liquid surface while stirring with a magnetic stirrer. The point at which no more sample can be observed on the liquid surface sample is considered as the end point, and the degree of hydrophobization is calculated by the following formula.
degree of hydrophobization (%)=X/(50+X)×100
where X=amount of methanol used (ml)

In addition, in the magnetic single component toner for electrostatic latent image development of the present invention, a microparticle (in general, with a mean particle diameter of 1.0 μm or less) for conferring fluidity and polishability, such as, colloidal silica, hydrophobic silica and titanium oxide, can be added as an external additive, in addition to the above-mentioned strontium titanate. By treating the surface of the toner particle with these external additives, fluidity, storage stability, cleanability and the like can be improved. These external additives are used, in general, at a proportion of 0.2 to 10.0 parts by mass for 100 parts by mass of toner particle.

Next, a method for preparing the magnetic single component toner for electrostatic latent image development of the present invention will be described. The magnetic single component toner for electrostatic latent image development of the present invention is obtained by mixing various toner compounding agents such as binding resin, magnetic powder and charge control agents, which are melted and kneaded using a kneader such as an extruder, then cooled, ground and separated. It is preferred that this toner, in general, be separated and the granularity thereof adjusted so that the mean particle diameter thereof is on the order of 5 to 10 μm. In contrast, if the mean particle diameter is smaller than this range, this will cause fluidity to drop and give rise to fog; in addition, if it is larger than this range, there is the risk of reduced image quality, which is not desirable.

In addition, the strontium titanate, silica microparticle and the like are added by dry stirring and mixing with toner. This stirring and mixing is carried out using a Henschel mixer, a Nauta mixer or the like, without the external additives being embedded in the toner.

In the following, examples and comparative examples will be given to describe in detail the magnetic single component toner for electrostatic latent image development of the present invention; however, the present invention is not limited to the following examples.

### EXAMPLE 1

>Preparation of Strontium Titanate<

Metatitanic acid TiO₂.H₂O obtained by the sulfuric acid method was deironized and bleached, then an aqueous solution of sodium hydroxide was added to bring the pH to 9.0, and desulfurization was performed. Then, the solution was neutralized to pH 5.5 with hydrochloric acid and washed with water over a filter, and water was added thereto to obtain TiO₂ as a 1.25 mol/L slurry. Hydrochloric acid was added to this slurry to bring the pH to 1.2, and deflocculation was carried out. This deflocculated metatitanium slurry was placed in a 3 L reaction vessel, in the amount of 0.626 mol of TiO₂, an aqueous solution of strontium chloride was added to this slurry to obtain an SrO/TiO₂ molar ratio of 1.15, then the solution was adjusted to 0.626 mol/L of TiO₂, nitrogen gas was blown in, and the solution was left to stand for 20 minutes.

Next, nitrogen was blown into this reaction vessel, the mixed solution of metatitanic acid and strontium chloride was heated to 90° C. while stirring and mixing, then 150 ml of an aqueous solution of 10 N sodium hydroxide was added over 24 hours, whereafter stirring was continued at 90° C. for one hour, and the reaction was terminated. After the reaction, the solution was cooled to 40° C., a process was repeated twice, which consisted of removing the supernatant under nitrogen atmosphere, adding 2.5 L of pure water and decanting, and a cake obtained after washing and filtration was dried for 8 hours in an atmosphere at 110° C. to obtain strontium titanate. This strontium titanate was treated for hydrophobization with trimethyl methoxy silane to obtain strontium titanate having a specific surface area and a degree of hydrophobization shown in Table 1.

Note that, the above-mentioned preparation method is a preparation example, and strontium titanate obtained by different methods can also be used, so long as it falls within the defined ranges of the present invention.

(Method for Measuring Specific Surface Area [BET Specific Surface Area])

The specific surface area was measured using a model 2200 BET specific surface area analyzer manufactured by Micromeritic. Specifically, approximately 100 mg of measurement sample was weighed in the cell, degassing was performed at a temperature of 40° C. and a 1.0×10⁻³ mmHg vacuum for 12 hours then, under liquid nitrogen cooling, nitrogen gas was adsorbed, and the value of the specific surface area was determined from the resultant substance, using the multi point method.

<Preparation of Binding Resin>

In a reactor with a thermometer, a magnetic stirrer and a nitrogen introduction tube, 300 parts by mass of xylene was introduced, a mixed monomer of 845 parts by mass of styrene and 155 parts by mass of n-butyl acrylate, and a mixed solution of 8.5 parts by mass of di-tert-butylperoxide (polymerization initiator) and 125 parts by mass of xylene were used to for instillation at 170° C. over 3 hours under nitrogen stream. After instillation, reaction was carried out at 170° C. for one hour to complete polymerization. Thereafter, the solvent was removed to obtain the binding resin.

<Preparation of Toner>

A mixture of 49 parts by mass of the binding resin obtained above, 45 parts by mass of magnetic powder, 3 parts by mass of wax and 3 parts by mass of positive charge control agent were mixed in a Henschel mixer, then the mixture was melted and kneaded with a two-axis extruder and cooled, then coarsely ground with a hammer mill. This coarsely ground material was further ground finely with a mechanical grinder, then separated with an airflow separator to obtain a toner particle with a volumetric mean particle diameter of 8.0 μm.

A predetermined quantity as shown in Table 1 of the strontium titanate obtained above was added to 100 parts by mass of the toner particles, and silica in the amount of 1 part by mass was added for 100 parts by mass of the toner particles, and then externally added to this toner particle with a Henschel mixer so that strontium titanate and silica were attached onto the surface of the toner particles, so as to prepare a positively chargeable magnetic single component toner.

The details of each source material constituting the above toner are shown below.

Magnetic powder: holding power of 5.0 kA/t when applying 796 kA/m, magnetization saturation of 82 Am²/kg, residual magnetization of 11 Am²/kg, and individual mean particle diameter of 0.25 μm.

Wax: product name “Sasol Wax H1” manufactured by Sasol

Positive charge control agent: quaternary ammonium salt (product name “Bontron P-51” manufactured by Orient Chemical).

Silica: product name “RA-200H” manufactured by Nippon Aerosil.

Using this toner, and using a page printer LS-3800 equipped with an amorphous silicon photosensitive member (film thickness in the amorphous silicon photosensitive member: 16 μm; equipped with a cleaning blade; 24 copies [A4 size] per minute; linear speed: 147 mm/second) manufactured by Kyocera, the status of insulation damage on the photosensitive member, image characteristics and charging characteristics were evaluated. The evaluation method for each characteristic is shown below, and the evaluation results thereof are shown in Table 2. Note that, “Initially” and “After printing 100,000 copies” in Table 2 have the following meanings.

Initially: each characteristic immediately after delivery of an image when the above toner was set in the above page printer.

After printing 100,000 copies: evaluation of each characteristic after printing 100,000 copies at consecutive paper throughput (print ratio 5%)

<Status of Insulation Damage on the Photosensitive Member (Number of Black Spots on the Photosensitive Member)>

The number of black spots (count of insulation damage on the photosensitive member film versus the number of prints) occurring due to insulation damage on the photosensitive member after printing 100,000 copies using the above page printer was measured using a dot analyzer (product name “DA-5000S” manufactured by Oji Scientific Instruments). Note that the measurement range for black spots was a region of 5 mm×210 mm in the A4 horizontal direction.

<Image Characteristics (Image Density/Fog)>

In an environment of room temperature and ambient humidity (20° C., 65% RH), an image evaluation pattern was printed with the above page printer at initial time to serve as the initial image, thereafter, consecutive paper throughput was performed for 100,000 copies, the image evaluation pattern was printed again to serve as the after-endurance image, and the respective solid images were measured using a MacBeth reflective densitometer (RD914), and simultaneously, fog was checked visually, for evaluation of image characteristics. The image density was noted with a circle when 1.30 or above, and with an X when less than 1.30. In addition, the following judgment criteria were used for evaluation of fog.

Circle: no fog observed.

Triangle: some fog generated.

X: very bad fog.

<Charging Characteristics (Charge Amount)>

The amount of charge in the toner on the development sleeve integrated in the developing agent bearing body of the page printer was measured using an aspiration charge-to-mass meter (Q/M Meter 210HS) manufactured by TRek, and from the change in weight when so doing, the charge amount per gram of toner was determined in μC/g.

<Photosensitive Member Surface>

Contamination on the photosensitive member was visually observed after printing 100,000 copies using the above page printer. Note that the following judgment criteria was used for evaluation of photosensitive member contamination.

Circle: no filming, damage or the like on the surface.

Triangle: slight filming or damage is observed.

X: filming or damage occurred.

### EXAMPLE 2

Strontium titanate having the specific surface area and degree of hydrophobization shown in Table 1 was produced in the same manner as in Example 1, except that the amount of deflocculated titanium oxide slurry placed in the 3 L reaction vessel constituted 0.313 mol of TiO₂, an aqueous solution of strontium chloride was added thereto, then the solution was adjusted to 0.313 mol/L of TiO₂, and in place of 150 ml of an aqueous solution of 10 N sodium hydroxide, 150 ml of an aqueous solution of 5N sodium hydroxide was added over 6 hours. Then, a magnetic single component positively charged toner was produced in the same manner as in Example 1, except that a predetermined quantity shown in Table 1 of this strontium titanate was added to the toner. The resulting toner was evaluated for each characteristic, in the same way as in Example 1. The evaluation results are shown in Table 2.

### EXAMPLE 3

Strontium titanate having the specific surface area and degree of hydrophobization shown in Table 1 was produced in the same manner as in Example 1, except that the amount of deflocculated titanium oxide slurry placed in the 3L reaction vessel constituted 0.939 mol of TiO₂, an aqueous solution of strontium chloride was added thereto, then the solution was adjusted to 0.939 mol/L of TiO₂, and in place of 150 ml of an aqueous solution of 10N sodium hydroxide, 150 ml of an aqueous solution of 15N sodium hydroxide was added over 36 hours. Then, a magnetic single component positively charged toner was produced in the same manner as in Example 1, except that a predetermined quantity shown in Table 1 of this strontium titanate was added to the toner. The resulting toner was evaluated for each characteristic, in the same way as in Example 1. The evaluation results are shown in Table 2.

### EXAMPLES 4 AND 5

A magnetic single component positively charged toner was produced in the same manner as in Example 1, except than the predetermined quantities shown in Table 1 of strontium titanate were added to the toner. Then, this toner was evaluated for each characteristic, in the same way as in Example 1. The evaluation results are shown in Table 2.

### COMPARATIVE EXAMPLE 1

a Magnetic Single Component Positively Charged Toner was Produced in the Same Manner as in Example 1, except that, in place of the strontium titanate, titanium oxide having the specific surface area and degree of hydrophobization shown in Table 1 was used. Then, this toner was evaluated for each characteristic, in the same way as in Example 1. The evaluation results are shown in Table 2.

### COMPARATIVE EXAMPLE 2

A magnetic single component positively charged toner was produced in the same manner as in Example 1, except that, in place of the strontium titanate, barium titanate having the specific surface area and degree of hydrophobization shown in Table 1 was used. Then, this toner was evaluated for each characteristic, in the same way as in Example 1. The evaluation results are shown in Table 2.

### COMPARATIVE EXAMPLE 3

Strontium titanate having the specific surface area and degree of hydrophobization shown in Table 1 was produced in the same manner as in Example 1, except that the deflocculated titanium oxide slurry placed in the 3 L reaction vessel constituted 0.313 mol of TiO₂, an aqueous solution of strontium chloride was added thereto, then the solution was adjusted to 0.313 mol/L of TiO₂, and in place of 150 ml of an aqueous solution of 10N sodium hydroxide, 150 ml of an aqueous solution of 5N sodium hydroxide was added over 4.5 hours. Then, a magnetic single component positively charged toner was produced in the same manner as in Example 1. The resulting toner was evaluated for each characteristic, in the same way as in Example 1. The evaluation results are shown in Table 2.

### COMPARATIVE EXAMPLE 4

Strontium titanate having the specific surface area and degree of hydrophobization shown in Table 1 was produced in the same manner as in Example 1, except that the deflocculated titanium oxide slurry placed in the 3 L reaction vessel constituted 0.939 mol of TiO₂, an aqueous solution of strontium chloride was added thereto, then the solution was adjusted to 0.939 mol/L of TiO₂, and in place of 150 ml of an aqueous solution of 10N sodium hydroxide, 150 ml of an aqueous solution of 15N sodium hydroxide was added over 42 hours. Then, a magnetic single component positively charged toner was produced in the same manner as in Example 1. The resulting toner was evaluated for each characteristic, in the same way as in Example 1. The evaluation results are shown in Table 2.

### COMPARATIVE EXAMPLES 5 AND 6

A magnetic single component positively charged toner was produced in the same manner as in Example 1, except that the predetermined quantities shown in Table 1 of strontium titanate were added to the toner. Then, this toner was evaluated for each characteristic, in the same way as in Example 1. The evaluation results are shown in Table 2.

TABLE 1
Additive formulation summary

| | | Specific | | |
|---|---|---|---|---|
| | | surface | | Degree of |
| | | area | Amount added | hydrophobicity |
| | Additive | (m²/g) | (mass part) | (%) |
| Example 1 | strontium | 16.5 | 2.0 | 55 |
| | titanate | | | |
| Example 2 | strontium | 8.8 | 2.0 | 57 |
| | titanate | | | |
| Example 3 | strontium | 28.1 | 2.0 | 53 |
| | titanate | | | |
| Example 4 | strontium | 16.5 | 0.5 | 55 |
| | titanate | | | |
| Example 5 | strontium | 16.5 | 4.6 | 55 |
| | titanate | | | |
| Comparative | titan oxide | 20.1 | 2.0 | 52 |
| Example 1 | | | | |
| Comparative | barium | 12.3 | 2.0 | 58 |
| Example 2 | titanate | | | |
| Comparative | strontium | 6.9 | 2.0 | 58 |
| Example 3 | titanate | | | |
| Comparative | strontium | 33.4 | 2.0 | 53 |
| Example 4 | titanate | | | |
| Comparative | strontium | 16.5 | 0.1 | 55 |
| Example 5 | titanate | | | |
| Comparative | strontium | 16.5 | 5.6 | 55 |
| Example 6 | titanate | | | |

TABLE 2
Evaluation result summary

| | | | | | After printing 100,000 copies | | | | | |
|---|---|---|---|---|---|---|---|---|---|---|
| | Initially | | | | | | | | Number of | |
| | Charge | | | | Charge | | | | black spots | |
| | amount | Image | | | amount | Image | | | on | Photosensor |
| | (μC/g) | density | | Fog | (μC/g) | density | | Fog | photosensor | surface |
| Example 1 | 3.3 | 1.42 | ◯ | ◯ | 4.6 | 1.32 | ◯ | ◯ | 0 | ◯ |
| Example 2 | 3.0 | 1.37 | ◯ | ◯ | 3.5 | 1.32 | ◯ | ◯ | 0 | ◯ |
| Example 3 | 3.7 | 1.39 | ◯ | ◯ | 4.0 | 1.34 | ◯ | ◯ | 0 | ◯ |
| Example 4 | 3.1 | 1.40 | ◯ | ◯ | 4.5 | 1.36 | ◯ | ◯ | 0 | ◯ |
| Example 5 | 2.9 | 1.36 | ◯ | ◯ | 4.2 | 1.31 | ◯ | ◯ | 0 | ◯ |
| Comparative | 6.0 | 1.32 | ◯ | ◯ | 10.5 | 1.29 | ◯ | ◯ | 1219 | ◯ |
| Example 1 | | | | | | | | | | |
| Comparative | 7.7 | 1.30 | ◯ | ▴ | 9.1 | 1.10 | X | ▴ | 2457 | ▴ |
| Example 2 | | | | | | | | | | |
| Comparative | 5.4 | 1.31 | ◯ | ◯ | 7.8 | 1.25 | X | ▴ | 986 | X |
| Example 3 | | | | | | | | | | |
| Comparative | 7.2 | 1.27 | X | ◯ | 9.9 | 1.19 | X | ▴ | 11 | X |
| Example 4 | | | | | | | | | | |
| Comparative | 9.6 | 1.10 | X | ▴ | 11.1 | 1.01 | X | X | 2895 | X |
| Example 5 | | | | | | | | | | |
| Comparative | 2.7 | 1.26 | X | ▴ | 7.1 | 1.03 | X | X | 0 | X |
| Example 6 | | | | | | | | | | |

It is clear from Table 2 that Examples 1 to 5 show no problems after printing 100,000 copies in terms of the number of black spots on the photosensitive member and in terms of the photosensitive member surface, and no problems in terms of the charge amount, image density and fog initially and after printing 100,000 copies. In contrast, in Comparative Example 1, where titanium oxide was used as an external additive, a drop in the image density occurred and an insulation damage occurred on the photosensitive member, after printing 100,000 copies. Furthermore, in Comparative Example 2, where barium titanate was used as an external additive, fog was severe, and after printing 100,000 copies, a drop in the image density occurred, and contamination of the photosensitive member surface and insulation damage on the photosensitive member also occurred. In Comparative Example 3, where the specific surface area is less than the predetermined range, rather than being effective as a polishing agent, damage was observed on the photosensitive member, and after printing 100,000 copies, a drop in the image density and fog occurred, and an insulation damage on the photosensitive member also occurred. In Comparative Example 4, where the specific surface area is greater than the predetermined range, although not much insulation damage was observed, no effect as a polishing agent could be observed, and a contamination of the photosensitive member occurred. In addition, the value of the image density was low, and fog occurred after printing 100,000 copies. In Comparative Example 5, where the amount added was less than the predetermined range, no effect of the present invention was obtained, the charge increased, image density was low, fog was severe, and insulation damage on the photosensitive member and contamination of the photosensitive member surface occurred. In Comparative Example 6, where the quantity added was greater than the predetermined range, fog and the like were observed initially, which further deteriorated after printing 100,000 copies. Moreover, the image density was low, and contamination of the photosensitive member surface occurred after printing 100,000 copies.

What is claimed is:

1. A magnetic single component toner for electrostatic latent image development, which is used in a magnetic single component toner projection development method using an amorphous silicon photosensitive member in which the thickness of a latent image support film is no greater than 30 μm, and a cleaning blade as a cleaning means for removing toner from the surface of this photosensitive member, so as to develop an electrostatic latent image formed on the photosensitive member with a developing agent bearing member, the magnetic single component toner for electrostatic latent image development comprising:
a toner particle comprising at least a binding resin and a magnetic powder, to which is added, as an external additive, at a ratio of 0.3 to 5.0 parts by mass with respect to 100 parts by mass of the toner particle, strontium titanate, which has been rendered hydrophobic and has a specific surface area of 8.0 to 30 m²/g.

2. A method for limiting insulation damage to an amorphous silicon photosensitive member, used in a magnetic single component toner projection development method using an amorphous silicon photosensitive member in which the thickness of a latent image support film is no greater than 30 μm, and a cleaning blade as a cleaning means for removing toner from the surface of this photosensitive member, so as to develop an electrostatic latent image formed on the photosensitive member with a developing agent bearing member, wherein the method uses:
the magnetic single component toner for electrostatic latent image development as recited in claim 1 as toner.
